(19) United States
(12) Patent Application Publication
(10) Pub. No.: US 2025/0018318 A1
(43) Pub. Date: Jan. 16, 2025

(54) FILTER DEVICE FOR THE HIGH-PRESSURE FILTRATION OF A PLASTIC MELT

(71) Applicant: Gneuss GmbH, Bad Oeynhausen (DE)

(72) Inventors: Stephan GNEUSS, Bad Oeynhausen (DE); Daniel GNEUSS, Charlotte, NC (US); Detlef GNEUSS, Carabietta (CH)

(73) Assignee: Gneuss GmbH, Bad Oeynhausen (DE)

(21) Appl. No.: 18/902,636

(22) Filed: Sep. 30, 2024

Related U.S. Application Data
(63) Continuation of application No. PCT/DE2023/100208, filed on Mar. 17, 2023.

(30) Foreign Application Priority Data
Apr. 7, 2022 (DE) 10 2022 108 497.3

(51) Int. Cl. B01D 33/15; B01D 33/50; B29B 13/10

(52) U.S. Cl. CPC B01D 33/155; B01D 33/50; B29B 13/10; B01D 2201/084

(57) ABSTRACT

A screen wheel filter device for a high-pressure filtration of a plastic melt. An inlet plate and an outlet plate are formed in a housing. At least one spacing element is arranged between the inlet plate and the outlet plate and a bearing ring on which a screen wheel is arranged between the inlet plate and the outlet place and is rotatably mounted. The screen wheel has a plurality of screen segments positioned between the inlet channel and the outlet channel. The inlet channel and the outlet channel each have a funnel opening expanding toward the screen wheel. At least one pressure relief bore is arranged in the inlet plate or in the outlet plate and opens at a bearing ring, and the pressure relief bore is fluidically connected to a relief opening in an outside of the housing via a pressure relief channel formed in the housing.

This nonprovisional application is a continuation of International Application No. PCT/DE2023/100208, which was filed on Mar. 17, 2023, and which claims priority to German Patent Application No. 10 2022 108 497.3, which was filed in Germany on Apr. 7, 2022, and which are both herein incorporated by reference.

### BACKGROUND OF THE INVENTION

### Field of the Invention

The invention relates to a filter device for the high-pressure filtration of a plastic melt.

### Description of the Background Art

In the filtering of plastic melts, agglomerates or solid particles must be filtered out before the melt can be fed to a further processing system such as an extrusion device with a die. In order to make possible interruption-free production, different types of filter devices are known that allow the replacement of a filter screen during ongoing operation by the means that a new screen that is not dirty is placed in the flow channel, and the dirty one is removed therefrom. A particular difficulty in the filtration of plastic melts is that this process must be carried out at high temperatures and at high pressures, which are between 250 bar and 300 bar even for normal applications.

A filter device of the generic type is described in principle in DE 3302343 A1 and EP 0 569 866 A1, which corresponds to U.S. Pat. No. 5,362,223, and which are all herein incorporated by reference. They permits the filtration of plastic melt and other medium-viscosity to high-viscosity fluids, wherein the distinction from low-viscosity media is a result of the construction, as is explained below. The screen wheel that carries the individual screening elements is positioned between two housing plates that are held at a certain distance from one another so that on the one hand the screen wheel is still rotatable, and on the other hand the gap between the sealing surfaces of the screen wheel and the adjacent sealing surfaces of the housing plates is so narrow in comparison with the viscosity of the filtered medium that no leakage flows occur that form in the gap which is open toward the outer sides. In brief, with a screen wheel filter device of the generic type, it is not possible to achieve a hermetic seal toward the outside, but instead the gap width is kept so small that the medium, on account of its viscosity, cannot flow to the outside along the gap that is open toward the outside between the screen wheel and the housing. Low-viscosity, watery media, by contrast, would flow out on the edge side and therefore cannot be processed on account of the open construction of the screen wheel filter device.

Also, DE 33 41 508 A1, which corresponds to U.S. Pat. No. 4,619,600, which is incorporated herein by reference, shows another filter device of the generic type in which a drive device is additionally disclosed. This drive device consists of a drive element in the form of a hydraulic cylinder that is attached to a side edge of the housing, a transfer lever, and a freewheel unit consisting of a pinion, which engages with external toothing of the screen wheel, and a freewheel that allows a return movement of the transfer lever without moving the screen disc in the process.

Additional screening devices with a rotatable screen wheel with multiple screen segments are known, for example, from DE 87 16 626 U1 (which corresponds to U.S. Pat. No. 4,850,840) and EP 0 287 048 A2 (which corresponds to U.S. Pat. No. 4,710,288), which are all incorporated herein by reference. No special measures are given for increasing the leak-tightness in high-pressure applications.

In the case of the screening device disclosed in DE102016113979 B3, which corresponds to US 2021/0170662, which is incorporated herein by reference, the leak-tightness is increased by the means that particular force relationships are provided in the plates that are braced against one another, by which means the gap width between the fixed housing elements and the movable screen wheel is kept small in the region of the sealing surfaces, and leakage flows are limited accordingly.

A screening device with a screen wheel for cleaning plastic melts for a high-pressure press is described in DE 39 02 061 A1, which corresponds to U.S. Pat. No. 5,090,887, which is incorporated herein by reference. A backflush device is provided in order to remove dirt adhering to the screening elements by a through-flow from the back of the screening elements, which is to say from the discharge side of the screening device. A flushing channel that can be closed off is provided for this purpose. Despite the mention of use in connection with high-pressure presses, no measures are specified for increasing the leak-tightness in high-pressure applications.

DE 3522050 A1 shows a screen-wheel filter device with a drive by means of a ratchet toothing formed on the outer circumference of the screen wheel and with a feed pushrod that engages with the toothing to move the screen wheel in steps.

In DE 299 08 735 U1, which corresponds to U.S. Pat. No. 6,325,922, a screen wheel filter device is described that has a backflushing mechanism. A mechanism for increasing the pressure in the backflush line is provided for the purpose of backflushing. There is no disclosure of an operation of the filter device at high pressures or of measures for controlling leakage flows.

DE 39 02 061 A1, which corresponds to U.S. Pat. No. 5,090,887, which is incorporated herein by reference, likewise describes a screen wheel filter device with a backflushing mechanism with no particular suitability for high pressure applications.

The screen wheel filter device shown in WO 2014/184 220 A1, which is incorporated herein by reference is aimed at minimizing pressure fluctuations, but likewise is not explicitly intended and suitable for high-pressure applications.

The particular advantages of a filter device of this generic type reside in that it is possible to place on the screen wheel a multiplicity of individual screens through which a flow can pass successively and which are easily accessible or can be replaced for cleaning purposes at a position on the housing facing away from the flow channel. The construction of the filter device is also simple and cost-effective on account of the layered construction of the housing.

The principal difficulty, however, resides in the sealing between the outer housing plates and the screen wheel enclosed therebetween. The housing parts must be braced against one another, with the inclusion of the screen wheel, in such a way that the flow pressure does not cause too much expansion of the housing, and consequently no corresponding leakage points are formed through which fluid escapes excessively at the side edges of the housing. On the other hand, a movability of the screen wheel must be present at all times, said wheel no longer being rotatable when it is clamped too tightly. Thus, a certain minimum gap width between the sealing surfaces on the face sides of the screen wheel and the opposite contact surfaces on the inlet and outlet plates on the housing side must be present in all operating states. The necessary gap width in this case also depends on the relevant fluid to be processed and its viscosity, on the processing temperature, and the flow pressure in the region of the screen segment. While one fundamental aim is thus tightness to leakage flows toward the edge side, on the other hand a sufficient gap width is also always necessary so that a very slight outflow of the fluid across the sealing webs is possible and a sort of lubricating film is formed by the fluid itself on both face sides of the screen wheel.

An appropriate adjustment of the height of the screen wheel and of the height of the spacer elements, which likewise are positioned between the inlet and outlet plates and which enclose the screen wheel, permits the setting of a gap width that is specific to the intended processing operation, but this width lies in the range of a few micrometers, so the manufacture of the spacer elements and the associated screen wheel, which together form the so-called internal pairing inserted between the inlet and outlet plates, is very difficult. It has been shown in practice that even with very careful calculation and manufacture of the gap widths, problems arise with regard to the movability of the screen wheel that can only be remedied by reducing the preloading, which in turn leads to the problem of leakiness.

In the modern concepts of a screen wheel filter device that are known per se, at least two screen segments at a time are simultaneously in the cross-sectional area through which flow passes, which is referred to hereinbelow as the throughflow region. The throughflow region is the surface area that is frontally impinged on by flow and usable for filtering. Usually, a first screen segment is in partial overlap with the throughflow region so that the operating pressure builds up in the arriving screen cavity. A further screen segment is positioned completely or almost completely within the throughflow region. A part of the second screen segment or a part of a third screen segment is located in partial overlap with the throughflow region at the upper edge viewed in the direction of rotation. The screen cavities intersected by the throughflow region that are moving into or out of the same are fully under operating pressure, however, even when they have only a small overlap in terms of area with the throughflow region. Consequently, the pressure region is larger than the throughflow region, and substantially constant-pressure operation of the filter device is made possible since there is no angular position of the screen wheel in which the flow path is interrupted fully or to a significant degree.

The plastic enclosed in the screen segment that is closed off in such a manner remains under the operating pressure of up to 500 bar as before. As a result, not only the region through which flow is directly passing and the adjacent surface areas of those screen segments that partially overlap the throughflow region are under pressure, but also the screen cavities that have already been moved out of the pressure region through which flow is actively passing. If one assumes a customary number of at least ten screen segments, in particular thirteen screen segments, on the screen wheel, then the region subjected to pressure extends in the direction of rotation from a first screen segment that has just come into partial overlap with the throughflow region all the way to the last screen segment before entry into a screen change position. Consequently, more than half of the screen segments located on the screen wheel are under high internal pressure and contribute to expansion of the lubrication gap and cause leakage flows.

In DE 10 2017 100 032 A1, which corresponds to US 2019/0344491, which is incorporated herein by reference, the relationships are described that arise regarding the geometry of the screen gap during operation. The gap width is not a geometrically constant quantity during operation, since the gap widens as a result of the internal pressure during filter operation; owing to the insertion of a gap width adjustment layer between the spacer elements and one of the adjacent housing plates, a specific operating point can be set such that, on the one hand, the gap is sufficiently large to be filled with the fluid that also serves as lubricant and to permit movement of the screen wheel, and such that, on the other hand, the gap width is limited far enough with respect to a maximum internal pressure in operation that no relatively large leakage flows occur. Uncontrolled leakage flows should be avoided so that assemblies that are arranged on the outside of the filter device, such as sensing elements, a pivoting door on a screen change station, or the drive for stepwise rotation of the screen wheel are not adversely affected by escaping fluid that solidifies on the outside. Such a setting of the operating point for customary operating pressures of approximately 250 bar, up to a maximum of 300 bar, is readily possible, in particular through the insertion of a gap width adjustment layer, wherein it is equally important for the free movement of the screen wheel in the nearly unpressurized state to be made possible and for leakage flows at maximum operating pressure to be prevented or reduced.

The difficulty of the adjustment for a specific operating state thus does not consist in designing the filter device for a specific operating point that is constant within narrow limits, but instead to ensure operation in the range from 0 bar to the maximum operating pressure. Here, the known concepts reach their limits at the said maximum pressures of 250 bar to 300 bar.

### SUMMARY OF THE INVENTION

It is therefore an object of the present invention to specify a high-pressure screen wheel filter device in which the functionality of the filter device is to be ensured equally well in an unpressurized state as at a different operating point at which the fluid is pressed through the filter device with a high pressure of up to 500 bar or more, without individual adjustment of the preloading of the housing parts before or during operation.

This object is attained, in an example, by a screen wheel filter device for the high-pressure filtration of a plastic melt.

A concept according to the invention provides that radial pressure relief flow paths are made possible. “Radial” in this sense can mean a flow from the position of the screen cavities inward toward the center or outward toward the outer circumference, in which flow passes over an annular sealing surface on the screen wheel that delimits the screen cavities, without it being necessary for the flow direction to be strictly radial in the geometric sense.

In particular, the bearing ring on which the screen wheel is supported in a sliding manner can be used for further pressure relief. Plastic melt that flows through the expanded screen gap in the vicinity of the pressure region reaches the bearing ring, which also is intended in principle for the purpose of forming a plain bearing. In high-pressure operation, however, more plastic melt passes locally into the region of the bearing ring than is required there for lubrication. In order to prevent axial leakage flows from forming along the bearing ring that escape frontally at the housing inlet plate or outlet plate, at least one additional pressure relief bore is provided that preferably is located at an angular position situated next to the throughflow region or below it, at most to the lowest point of the bearing ring. If the screen segment is located at a three o'clock position, for example, where twelve o'clock represents the top of the housing and six o'clock represents the bottom of the housing, then the radial pressure relief bore preferably is arranged at a position between two o'clock and six o'clock.

Another example of the invention makes provision to additionally provide in the housing at least one pressure relief bore that terminates in the track traversed by the screen segments during the rotation of the screen wheel and that is connected in a fluid-conducting manner via a flow channel to an outside of the housing. The region near the pressure relief bore thus forms a pressure sink, and a tangential flow path is created that extends essentially in the direction of rotation from the isolated screen cavity under pressure.

As a result, the screen cavities through which flow was previously passing and that are still under pressure are abruptly relieved of pressure when they are moved out of the throughflow region. Consequently, an expansion of the housing and an enlargement of the gap between the screen wheel and the adjacent housing plates is now caused only by the screen segments through which flow is directly passing. Nevertheless, no screen chambers remain that are under pressure longer, which contribute to expansion of the housing outside the pressure zone and for which a pressure reduction is possible only very slowly through leakage flows.

The tangential pressure relief provided according to the invention now occurs in such a manner that the screen segment located at the top, in front in the direction of rotation, comes into overlap with the mouth opening of a pressure relief bore as soon as this screen segment has completely left the pressure region and there is no longer a flow connection to the region of through-flow. To this end, geometric provision is made that the pressure relief bore terminates in the track traversed by the screen segments during the rotation of the screen wheel and is connected in a fluid-conducting manner via a flow channel to an outside of the housing. What is important here is that the distance between the mouth of the pressure relief bore and the front, upper edge—viewed in the direction of rotation—of the funnel mouth of the inlet and outlet channels is always greater than the maximum arc length of the screen segments. This has the result that the screen cavity is initially completely isolated from the region through which flow passes and that the screen wheel must then be rotated somewhat further before a flow connection can be established between the screen cavity that is isolated but still under pressure and the pressure relief bore.

Since plastic melts are compressible, the pressure relief occurs independently by the means that a small amount of plastic melt escapes and is carried away at the pressure relief bore. Once the pressure equalization is completed, the drainage of plastic melt out of the screen cavity abruptly stops again, which is to say the screen cavity remains filled.

Because a one-time pressure relief of each dirty screen segment is achieved in a targeted manner according to the example, the number of pressurized screen cavities can be limited to a maximum of three, of which at least two are in partial overlap with the throughflow region during operation and one is being moved to the pressure relief bore.

Since it is necessary for pressure relief to remove small quantities of the plastic fluid compressed in the screen segment, the removal preferably takes place starting from the pressure relief bore through a pressure relief channel that leads to the backflush region usually present at the bottom side of the screen wheel filter devices. Dirt particles adhering to the screening elements can be removed by means of the backflushing mechanism, for which purpose the removal of the plastic melt with the dirt particles is necessary, so the bottom side of the filter device is kept free of other mechanisms and suitable collectors can be provided there.

In particular, the pressure relief bore is provided on the side of the inlet plate. The backflush channel and the pressure relief channels should terminate in the same region of the filter device to the greatest possible extent in this case, namely in the lower region thereof, because then the material can be guided by gravity from there directly into a collecting vessel positioned beneath the filter device.

It is also possible to provide at least one pressure relief bore on the side of the outlet plate, since cleaned melt is present there, and to connect the pressure relief bore directly to the pressureless part of the backflush channel in the housing outlet plate. As a result, the backflushing of the screen insert elements in the screen cavities, which is necessary in any case, can be achieved at least partially with the quantity of plastic melt that has been carried away through the tangential flow path for pressure relief. Consequently, an additional function can be carried out by the fluid emerging in batches for pressure relief, and it is possible to reduce the power of the drive device of the backflush device by means of which a piston is moved, for example, in order to carry out the backflushing. Moreover, less melt must be diverted from the production flow for the backflushing. The pressure relief according to the invention thus does not cause any increased loss of the filtered medium on balance in a screen wheel filter device that is equipped in any case with a backflush device.

Another example provides for also catching and diverting the radial leakage flows that arise starting from the pressure region to the outer circumference of the screen wheel. These leakage flows get into the region of the external toothing of the screen wheel required for driving. If plastic melt settles there and is transported to the outside of the housing, it can solidify, which may possibly lead to impairment of the drive after several revolutions of the screen wheel. To counteract this, provision is made according to the invention to introduce another pressure relief opening in the gap between the toothing on the outer circumference of the screen wheel and the adjacent spacer element, so that any melt that has entered the gap can be carried away to the outside as a result of gravity, in particular likewise to the lower region of the housing whence it can drain into a collecting vessel placed thereunder.

It is advantageous to provide the at least one tangential pressure relief channel at the side of the inlet plate because free access to the screen cavity is present there, whereas facing away therefrom, which is to say on the back of the screen wheel, the opening is partially covered by the perforated plate that is inserted in the screen cavity and supports the actual screening elements.

The cross section in the flow direction—i.e., from the pressure relief bore to a relief opening on the bottom side of the housing—does not decrease over the course of the flow path, but instead preferably expands. This prevents foreign bodies or plastic slugs that have been deposited, e.g., from residual material from preceding production cycles, or degraded material from being able to cause a jam in the channel that would then impede the pressure relief. This design with an expanding channel cross section preferably applies to all channels for carrying material out of the housing to a collecting tray.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a housing of a screen wheel filter device;

FIG. 2 shows the perspective view as in FIG. 1, wherein the inlet plate of the housing is removed;

FIG. 3 shows a perspective view of the screen wheel filter device without the screen wheel, in an intermediate plane;

FIG. 4 shows a perspective view of the screen wheel filter device with inlet plate shown partially sectioned and transparent;

FIG. 5 shows a perspective view of the screen wheel filter device with the screen wheel, in an intermediate plane;

FIG. 6 shows a perspective, sectional view through the axis of rotation of the screen wheel; and

FIG. 7 shows an enlarged detail from FIG. 6.

### DETAILED DESCRIPTION

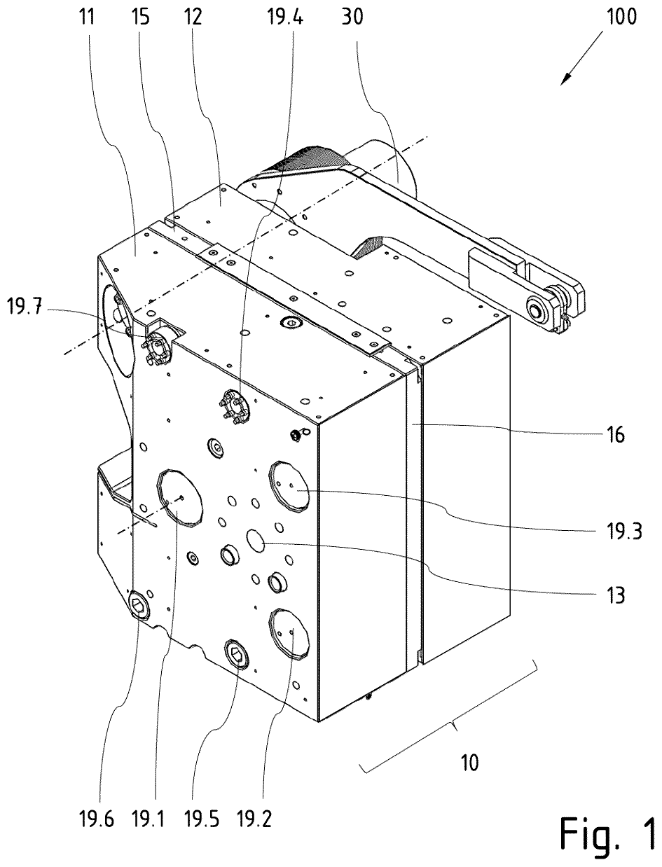

FIG. 1 shows a perspective view of a housing 10 of a screen wheel filter device 100 for the high-pressure filtration of a plastic melt, namely with a view of an inlet plate 11 with a feed channel 13. An outlet plate 12 is connected to the inlet plate 11 by spacer elements 15, 16, wherein a space is formed therebetween in which a screen wheel is supported. All three adjacent elements of the housing 10, which is to say the inlet plate 11, the spacer elements 15, 16, and the outlet plate 12, are bolted to one another by, collectively, housing clamping elements 19.1 to 19.3, and braced against one another with a preloading designed for the operating pressure. The central axis of the housing clamping element 19.1 in the center of the housing simultaneously constitutes the axis of rotation of the screen wheel. A drive mechanism 30 for the screen wheel is arranged on the outside of the housing 10.

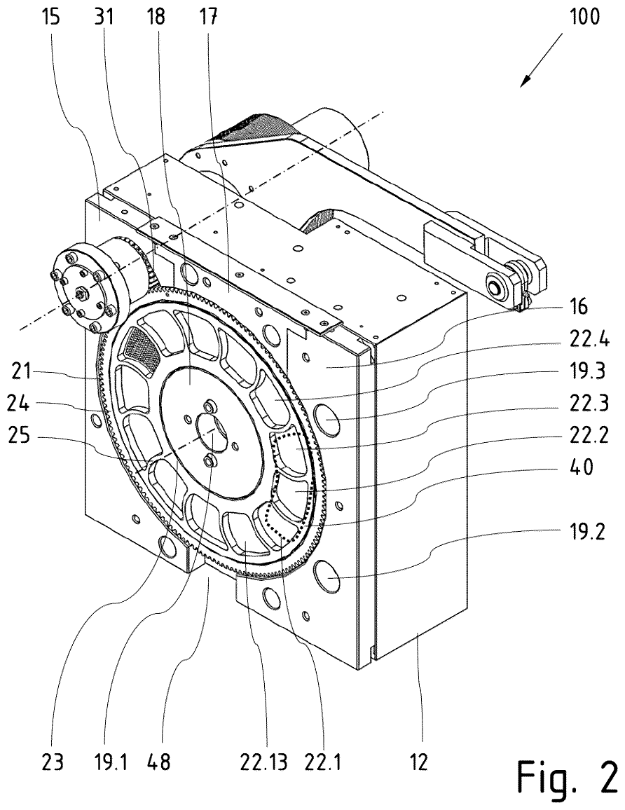

FIG. 2 is a perspective view of the screen wheel filter device 100 as in FIG. 1, although the inlet plate is removed so that the internal intermediate layer with the screen wheel 20 is visible. Moreover, an additional spacer element 17 is visible, which connects the two lateral spacer elements 15, 16 at the upper housing edge to one another with no gap. As a result, the screen wheel 20 is enclosed almost completely on the outer circumference. Openings in the housing 10 thus exist only at the top left in the region of a drive pinion 31, which engages with a ring gear 21, and at the bottom in the form of a relief opening 48, which serves to permit the targeted draining of melt into a collecting vessel placed beneath the filter device. In the example shown, the filter device has a drive that acts on the ring gear 21 by means of a drive pinion 31. In the case of an alternative drive by means of a pawl that engages with suitable toothing on the outer circumference, the housing has at least one additional opening in the upper region near the engagement point of the drive.

The screen wheel 20 is designed in a manner known per se with a multiplicity of screen segments 22.1 . . . 22.13; in the example shown, thirteen screen segments are provided. The screen segments 22.1 . . . 22.13 are each delimited by an inner annular sealing web 23 on the surface of the screen wheel 20, an outer annular sealing web 24, and webs 25 extending therebetween that run from the inside to the outside. Arranged in the center is a fixed bearing ring 18, on which the screen wheel 20 is supported. A plain bearing is formed between the outside of the bearing ring and the inside of the central bore of the screen wheel 20. A ring gear 21 is formed on the outer circumference of the screen wheel 20.

The housing clamping elements 19.1 to 19.3 cause a compression of the spacer elements 15, 16, 17 that are clamped between the outer housing plates to take place within a preloading area, and as a result the distance is reduced between the inlet and outlet plates 11, 12 and the screen wheel 20 enclosed between them.

The dotted line corresponds to the contours of the funnel-like mouths of the inlet and outlet channels on the screen wheel 20 and represents the throughflow region 40 that is usable for the filtration. The screen wheel 20 rotates counterclockwise. At the angular position of the screen wheel 20 shown in FIG. 2, the screen segment 22.1 is in partial overlap with the throughflow region 40. As a result, the operating pressure prevails in the entire screen segment 22.1 The screen segment 22.2 is located fully in the throughflow region 40. The screen segment 22.3 is likewise in partial overlap with the throughflow region 40, so the operating pressure prevails there, as well. The screen segment 22.4 has rotated out of the throughflow region 40, wherein the fluid held therein is still under operating pressure.

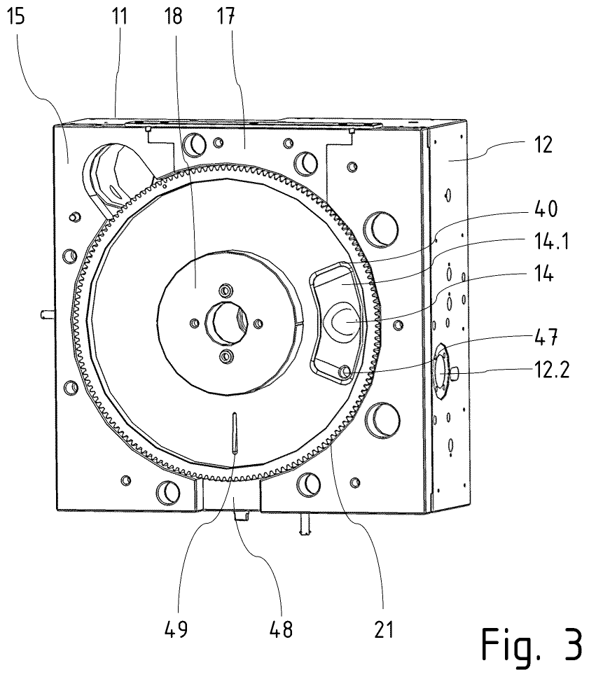

FIG. 3 is a perspective view of the screen wheel filter device 100 as in FIGS. 1 and 2, wherein the screen wheel is additionally removed here; for the purpose of orientation with regard to the position of the screen wheel, only its ring gear 21 is indicated. The contour of the funnel mouth 14.1 of the outlet channel 14 corresponds to the throughflow region 40. A backflush channel begins at a lateral opening 12.2 on the outlet plate 12 and terminates in an elongated, slot-like backflush nozzle 49 in the lower region of the screen wheel. During backflushing, fluid is drawn in at an intake opening 47 on the clean side of the screen and is pressed out at the backflush nozzle 49 by means of intensification by a shot piston carried in the backflush channel 12.2.

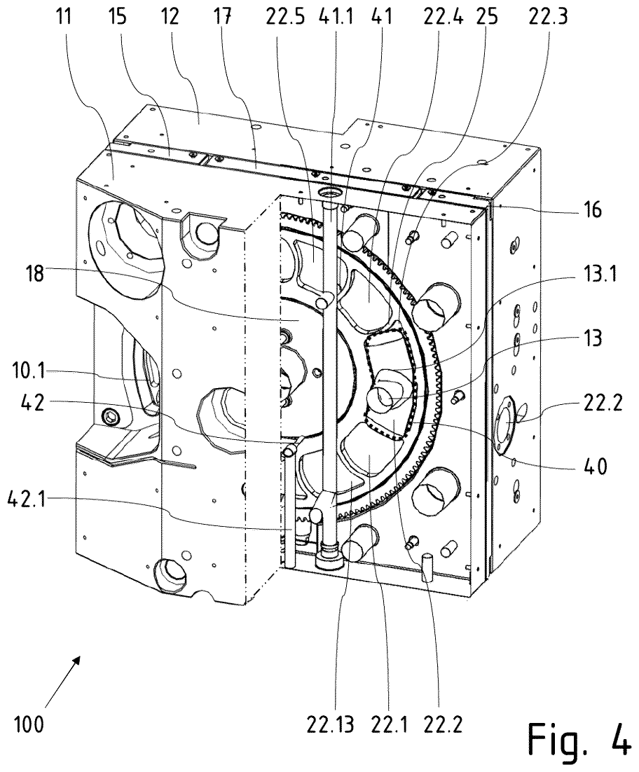

FIG. 4 depicts the filter device 100 with all housing elements and the screen wheel 20, wherein the right-hand region of the inlet plate 11 of the housing, where the inlet channel 13 is located, is shown partially sectioned and transparent. Provided on the housing on the left is a screen replacement position 10.1, at which the inlet plate 11 is open so that a replacement of the screening elements can be carried out there. The screen replacement position 10.1 can be closed by means of a door. The expansion of the inlet channel 13 to a funnel mouth opening 13.1 is clearly visible. This opening is identical in placement and shape to the funnel mouth opening 14.1 (see FIG. 3) on the outlet plate 12. Formed between them is the throughflow region 40, shown with a dotted outline, in which the plastic melt flows through the screening elements inserted in the screen segments 22.1 . . . 22.13.

At the position of the screen wheel 20 in FIG. 4, the screen segment 22.5 is just in overlap with the pressure relief bore 41, which is routed laterally to the screen wheel 20 and continues downward in a pressure relief channel 41.1. The screen cavity at the screen segment 22.5 is thus already pressureless. The screen segment 22.4 that follows in the counterclockwise rotation is still under high internal pressure. It is no longer in overlap with the throughflow region 40 and is completely closed off from the next following screen segment 22.3 by the sealing web 25. The screen segments 22.2, 22.3 are located completely in the throughflow region 40. The screen segment 22.1 is just coming into overlap with the throughflow region 40. If a screen replacement has taken place beforehand, a preflooding takes place at this segment and the internal pressure builds up.

A further pressure relief bore 42 leads from the side directly to the plain bearing surface between the inner circumference of the bearing bore of the screen wheel 20 and the bearing ring 18 tightly clamped in the housing. It continues downward in a further pressure relief channel 42.1.

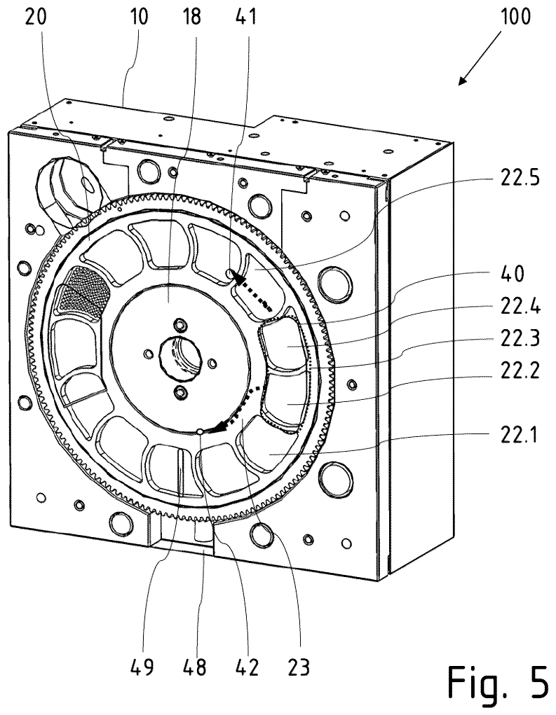

FIG. 5 shows a vertical section through the housing 10 with a view of the screen wheel 20, wherein the section plane is in an intermediate plane in which a lubrication gap is formed, and extends parallel to the plane of the screen wheel 20. The dotted arrows indicate the approximate directions of flow of the plastic melt starting from screen segments 22.2, 22.3 in the throughflow region 40 or in the vicinity thereof to the pressure relief bores 41, 42. They differ in that the flow to the first pressure relief bore 41 takes place at the top in the track of the screen segments 22.1 . . . 22.13 of the screen wheel and thus is approximately “tangential,” whereas the flow to the second pressure relief bore 42 surmounts the inner, annular sealing web 23 on the screen wheel 20 at the bottom, and therefore is referred to as “radial.”

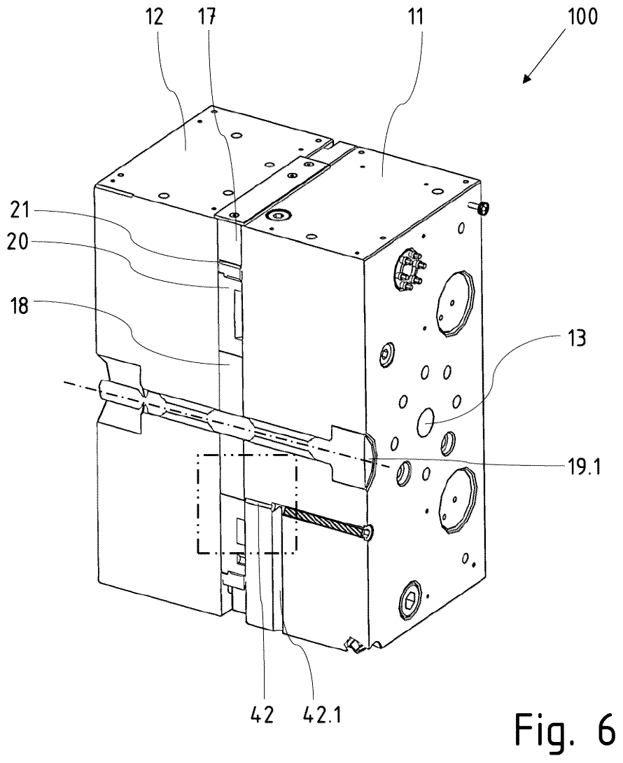

FIG. 6 is a perspective, sectional view through the axis of rotation of the screen wheel 20, which at the same time is the central axis of the housing clamping element 19.1 and of the bearing ring 18. The lower pressure relief bore 42 that continues downward in the pressure relief channel 42.1 is located in the section plane.

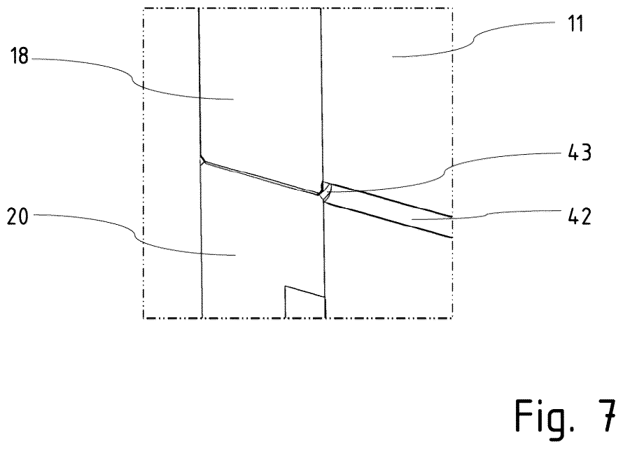

An important detail with respect to the pressure relief achieved with the second pressure relief bore 42, the so-called “radial” pressure relief, an important detail of the example of a screen wheel filter device 100 according to the invention, is only made clear by the enlargement in FIG. 7. At the point where the bearing ring 18 and the bore of the screen wheel 20 are adjacent to each other and form a plain bearing 26, the bearing ring 20 and the screen wheel are each provided with a bevel at the edge side so that an annular channel 43 with a triangular cross section is formed by the two adjacent bevels; this channel is markedly increased in volume compared with the annular gap of the plain bearing 26, and makes possible the removal of plastic melt for the purpose of pressure relief without the need to otherwise modify housing parts or the pairing of screen wheel 20 and bearing ring 18.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A screen wheel filter device for high-pressure filtration of a plastic melt, the screen wheel filter device comprising:
a housing comprising an inlet plate with at least one inlet channel and an outlet plate with at least one outlet channel;
at least one spacer element arranged between the inlet plate and the outlet plate;
a bearing ring on which a screen wheel is rotatably mounted and that is arranged between the inlet plate and the outlet plate;
at least two screen segments arranged on the screen wheel that each are adapted to be positioned between the inlet and outlet channels and through each of which a flow is adapted to pass;
a lubrication gap formed between the screen wheel and the inlet plate and between the screen wheel and the outlet plate;
a funnel mouth formed on each of the inlet channel and the outlet channel, each of the funnel mouths expanding toward the screen wheel, between which is formed a throughflow region;
at least one radial pressure relief flow path that crosses an inner, annular sealing web of the screen wheel and extends between the throughflow region;
at least one pressure relief bore formed within at least one lubrication gap; and
at least one pressure relief bore formed in the inlet plate or in the outlet plate, the at least one pressure relief bore terminating at the bearing ring, the pressure relief bore being connected in a fluid-conducting manner to a relief opening on an outside of the housing via a pressure relief channel formed at the housing.

2. The screen wheel filter device according to claim 1, wherein an annular channel, which is in flow connection with an annular plain bearing formed between the bearing ring and the screen wheel, is formed in the screen wheel and/or in the housing.

3. The screen wheel filter device according to claim 2, wherein the annular channel is formed by one bevel each on the outer circumference of the bearing ring and on the inner circumference of the bore of the screen wheel accommodating the bearing ring.

4. The screen wheel filter device according to claim 1, wherein at least one tangential pressure relief flow path, which extends between the throughflow region and at least one pressure relief bore terminating ahead of the throughflow region in a direction of rotation, is formed within at least one lubrication gap.

5. The screen wheel filter device according to claim 4, wherein the pressure relief bore is formed in the inlet plate and/or in the outlet plate, wherein the pressure relief bore terminates at a track traversed by the screen segments during the rotation of the screen wheel, wherein, when a screen segment overlaps with at least one pressure relief bore, there is no overlap of the screen segment with the throughflow region, and wherein the pressure relief bore is connected in a fluid-conducting manner to an outside of the housing via a pressure relief channel.

6. The screen wheel filter device according to claim 5, wherein a distance between the mouth of the pressure relief bore and the respective front edge, in the direction of rotation, of the throughflow region is greater than the maximum extent of the screen segments in the direction of rotation.

7. The screen wheel filter device according to claim 1, wherein the filter device is equipped with a backflushing mechanism, and wherein the pressure relief channel of the lower pressure relief bore and a backflush channel that leads to a backflush nozzle terminate at a common relief opening in the bottom side of the housing.
